(19) United States
(12) Patent Application Publication
(10) Pub. No.: US 2015/0026227 A1
(43) Pub. Date: Jan. 22, 2015

(54) Block Exponent Integer Data Format

(71) Applicants: Lai Xu, San Diego, CA (US); Ismail Lakkis, San Diego, CA (US); Yacoub Hirbawi, San Diego, CA (US)

(72) Inventors: Lai Xu, San Diego, CA (US); Ismail Lakkis, San Diego, CA (US); Yacoub Hirbawi, San Diego, CA (US)

(21) Appl. No.: 13/943,162

(22) Filed: Jul. 16, 2013

(51) Int. Cl. G06F 7/483

(52) U.S. Cl. CPC G06F 7/483
USPC 708/204

(57) ABSTRACT

A digital processing system comprises an input configured for receiving data in block exponent integer format, wherein each block comprises a plurality of data values sharing a single exponent. The plurality of data values has a common data bit width, and the exponent has an exponent bit width. An arithmetic processor performs arithmetic operations on the input data to produce output data in block exponent integer format. The arithmetic processor comprises a format optimizer for reducing at least one of the data bit width and the exponent bit width prior to performing arithmetic operations. The bit width is reduced to improve system power efficiency while meeting a predetermined target system performance.

### BACKGROUND

1. Field of the Invention

The present disclosure relates generally to methods and systems for performing arithmetic calculations in digital processing systems, and devices that use such processing systems.

2. Introduction

Efficient implementations of digital signal processing (DSP) systems to minimize power consumption are important for extending the battery life of mobile wireless devices. In baseband processing, circuit systems with high-throughput modulators and decoders require large numbers of operations and tend to increase power consumption. In digital hardware implementations of signal processing, appropriate data format, and bit widths must be determined. Data format and bit widths affect hardware sizes, power dissipation, and system performance. In conventional fixed point systems, a large bit width can consume unnecessarily high amounts of circuit power, while a small bit width can degrade system performance if the dynamic range is insufficient.

DSP algorithms are often implemented using conventional fixed point numbers in hardware design because floating point multiply-accumulator hardware is usually slower than fixed point. Also, fixed-point architectures are more energy efficient than floating-point architectures. Energy consumption of an application depends on the data format and the bit width of the manipulated data. Thus, the energy consumption can be reduced by decreasing the bit widths and using a format that is amenable to low complexity arithmetic operations.

### SUMMARY

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

In accordance with aspects of the disclosure, data is formatted to employ a block exponent integer (BEI) representation, wherein each block of numbers shares a common exponent. BEI format expresses a block (such as an array of numbers) as an array of data parts D, wherein the block is scaled by a common exponent, such as a base-2 exponent E. The exponent part E has a fixed or variable bit width EW, and each of the data parts D in the block has the same variable bit width, DW. The block of numbers is formatted such that the plurality (i.e., parallel factor PF) of the block's data parts D shares a single exponent part E. In one aspect of the invention, both in-phase (I) and quadrature-phase (Q) parts of a data value may share the same exponent part E.

BEI may be employed to improve the system power efficiency while meeting a predetermined target system performance. The bit width DW may be regarded as providing for resolution, and the bit width EW may be regarded as providing for the dynamic range of the block. For example, DW may be reduced when less resolution is required in a microprocessor, and EW may be reduced when less dynamic range is required.

In some aspects of the invention, a first DW and EW are employed at the input of a first DSP stage, and a second DW and EW are employed at the input of a second DSP stage, wherein a stage is a digital portion of a baseband processor. In accordance with some aspects, a plurality of different block bit widths may be employed wherein each of the different block bit widths is processed by its own hardware.

In accordance with one aspect of the invention, hardware configured to process BEI-formatted data has specified inputs comprising a fixed DW and a fixed EW, and specified outputs comprising a fixed DW and a fixed EW. In VLSI architectures employed for digital communications, the values of EW and/or DW may be changed during system operation. The hardware may perform predetermined operations that cause the internal state(s) of at least one of DW and EW to differ from its input and output values. In some aspects, DW and/or EW may vary depending on the data values from which the BEI-formatted blocks are generated.

One aspect of the disclosure comprises a method for operating a digital processing system to align exponents of a pair of blocks in BEI format, wherein the pair of blocks comprises a first block having a first data portion and a first exponent, and a second block having a second data portion and a second exponent. This method comprises setting the first exponent equal to the second exponent if all data values in the first data portion equal zero and at least one of the data values in the second data portion is non-zero; setting the second exponent equal to the first exponent if all data values in the second data portion equal zero and at least one of the data values in the first data portion is non-zero; setting the first exponent and the second exponent to zero if all data values in the first data portion and in the second data portion equal zero; setting the second data portion equal to zero and setting the second exponent equal to the first exponent if the first exponent exceeds the second exponent be a predetermined limit value; setting the first data portion equal to zero and setting the first exponent equal to the second exponent if the second exponent exceeds the first exponent be a predetermined limit value; setting the first exponent equal to the second exponent and scaling down the first data portion by an amount equal to 2 to the power of the first exponent minus the second exponent if the first exponent is less than the second exponent and the second exponent exceeds the first exponent by less than the predetermined limit value; and setting the second exponent equal to the first exponent and scaling down the second data portion by an amount equal to 2 to the power of the second exponent minus the first exponent if the second exponent is less than the first exponent and the first exponent exceeds the second exponent by less than the predetermined limit value.

Another aspect of the disclosure comprises a method for operating a digital processing system for optimizing data having a BEI format. The method comprises providing an input comprising a target DW while DW of the input block is greater than the target DW, decrementing DW by removing unused MSBs; and while the bit width is still greater than the target DW, truncating the LSBs and increasing the exponent value E.

In a method for operating a digital processing system for summing a pair of numbers in BEI format according to an aspect of the disclosure, a BEI align function is performed on a pair of BEI blocks before the data portion of the blocks is summed. In one aspect of the disclosure, the resulting sum can be processed by a BEI optimize function.

In a method for operating a digital processing system for multiplying a pair of BEI blocks according to an aspect of the invention, a BEI-optimize function can be performed on the resulting product.

In some aspects, the BEI data can be conditioned to facilitate or improve mathematical computations. For example, different DW and/or EW may be employed from one DSP block or stage to the next, such as to improve the computation efficiency, power consumption, and other operating merits of a DSP system, while the exponential part E provides the system dynamical range. Some aspects of the invention provide each DSP stage with fixed input DWᵢ and EWᵢ, and fixed output DWₒ and EWₒ. However DWᵢ may differ from DWₒ and EWᵢ may differ from EWₒ.

In some aspects of the disclosure, reducing DW and/or EW may provide an equitable tradeoff between power consumption and the quality of the computations. For example, DW and/or EW may be reduced to conserve power while resulting in a tolerable loss of computational precision and/or accuracy. In many systems this acceptable threshold can change due to external operating conditions and can vary over time. Thus, it can be advantageous to employ different values of DW and/or EW from one DSP stage to another.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the invention will become more fully apparent from the following description and appended claims, or may be learned by the practice of the invention as set forth herein.

### BRIEF DESCRIPTION OF THE DRAWINGS

In order to describe the manner in which the above-recited and other advantages and features of the invention can be obtained, a more particular description of the invention briefly described above will be rendered by reference to specific aspects thereof, which are illustrated in the appended drawings. These drawings depict only typical aspects of the invention and are not therefore to be considered to be limiting of its scope. Aspects of the invention will be described and explained with additional specificity and detail through the use of the accompanying drawings.

FIG. 1A depicts a BEI format.

FIG. 1B depicts a BEI representation of data.

FIG. 2A is a flow diagram of a method for operating a digital processing system for converting a vector of decimal numbers to BEI format.

FIG. 2B is a flow diagram of a method for operating a digital processing system for converting a set of numbers from BEI format into a vector of decimal numbers.

FIG. 2C depicts a digital signal processing (DSP) stage in accordance with an aspect of the invention.

FIG. 3 depicts input and output data values associated with a BEI align function in accordance with one aspect of the invention.

FIG. 4 is a flow diagram of a method for operating a digital processing system for aligning exponents of a set of numbers in BEI format.

FIG. 5 depicts data operations of the BEI optimize function in accordance with some aspects of the invention.

FIG. 6 is a flow diagram of a method for operating a digital processing system for performing a BEI optimization function on a set of numbers in BEI format.

FIGS. 7A-7C together depicts a process whereby a pair of BEI-formatted numbers is summed. FIG. 7A represents an input block. FIG. 7B depicts an extend-by-one bit of the input block. FIG. 7C depicts the result of a sum.

FIG. 8A is a flow diagram of a method for operating a digital processing system for summing a pair of numbers in BEI format according to an aspect of the invention.

FIG. 8B is a flow diagram of a method for operating a digital processing system for summing a pair of numbers in BEI format according to another aspect of the invention.

FIG. 9 depicts data operations performed during the multiplication of a pair of BEI numbers according to aspects of the invention.

FIG. 10A is a flow diagram of a method for operating a digital processing system for multiplying a pair of BEI blocks according to an aspect of the invention.

FIG. 10B is a flow diagram of a method for operating a digital processing system for multiplying a pair of BEI blocks according to another aspect of the invention.

### DETAILED DESCRIPTION

Various aspects of the disclosure are described below. It should be apparent that the teachings herein may be embodied in a wide variety of forms and that any specific structure, function, or both being disclosed herein are merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

In the following description, for the purposes of explanation, numerous specific details are set forth in order to provide a thorough understanding of the invention. It should be understood, however, that the particular aspects shown and described herein are not intended to limit the invention to any particular form, but rather, the invention is to cover all modifications, equivalents, and alternatives falling within the scope of the invention as defined by the claims.

The present disclosure is directed to techniques for employing a BEI representation of data in digital signal processing operations. As will be described in greater detail below, BEI format expresses a set of numbers as a block, or an array, of data parts D(0), . . . , D (N−1), each with bit width DW. Each of the data parts D(0), . . . , D(N−1) is scaled by the same exponent part, E, having bit width EW. The exponent part E may represent a base-2 exponent. Since one value of E is common to all the data parts, only that single value of E is used in the BEI format to express all the exponent parts for the block. For example, an n^{th} number of the block has a value expressed by: D(n)×2^{E}.

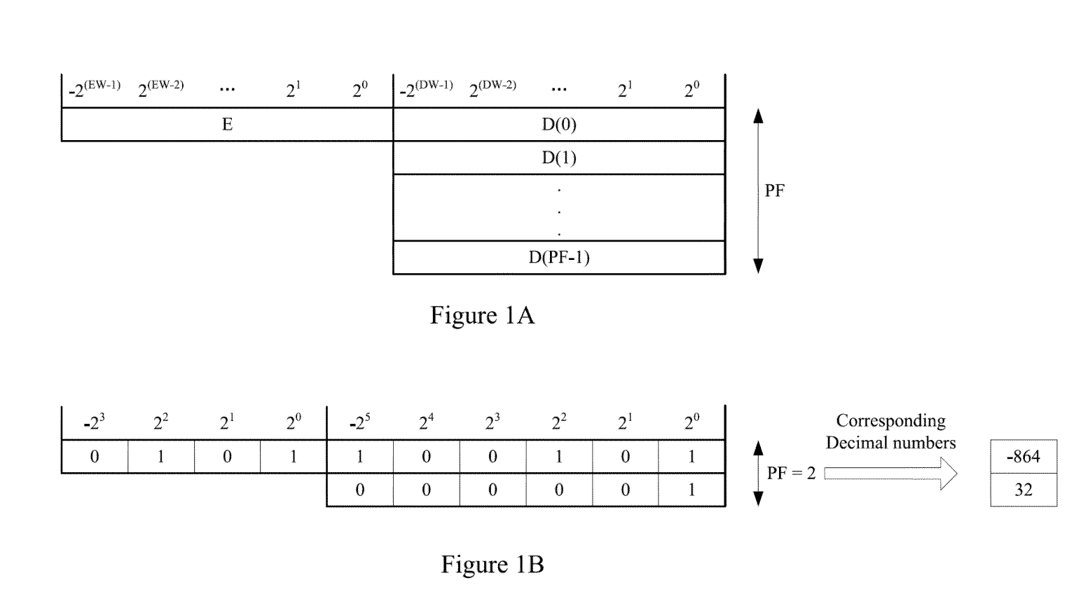

FIG. 1 depicts a BEI format for a block of numbers in accordance with an aspect of the invention. The data part of the block comprises a plurality N of data values D(0), . . . , D(N−1), where PF=N is referred to as a parallel factor. Each value of D, {D(0), . . . , D(N−1)}, is in 2's complement format and comprises a number DW of bits. Specifically, each of the data parts D(0), . . . , D(N−1) has the same variable bit width, DW. In some aspects of the disclosure, the data parts D may comprise combinations of real and complex numbers.

The exponent part E has a fixed or variable bit width EW. The exponent part E is in 2's complement format and comprises a fixed or variable bit width EW. The block is formatted such that the plurality N of data parts D(0), . . . , D(N−1) shares the single exponent part E. In some aspects of the invention, I and Q measurements may comprise different data parts that share the same exponent.

FIG. 1B depicts a pair (N=2) of data values {−864, 32} in BEI format. The exponent part E of the block comprises 4 bits and has the value 5. The two data parts D(0) and D(1) of the block each comprise 6 bits. The first data part D(0) has the value −27, and the second data part D(1) has the value 1.

While FIG. 1A and FIG. 1B depict a 2's complement format for both the E and D values, other aspects of the invention may provide for alternative formats. For example, if the second most significant bit (MSB(2)) is not used by any of the data parts D(0), . . . , D(N−1) in a block, it can be omitted, which effectively reduces the bit width. In this case, the value of the most significant bit (MSB(1)) equals −2^{DW-1}, and the value of the new MSB(2) is 2^{DW-3}, which means that the effective bit width is DW-1. Similarly, one or more bits may be omitted from the exponent part E.

The following pseudo code depicts a conversion process of a set of numbers to a block in accordance with BEI format. In this case, the BEI format is defined as a struct data type, wherein each struct comprises a data element vector field “D” having 8 numbers, and an exponent field “E” that is set to zero.

function DDo=Dec2Bei(DDi),
DDo=[ ];

while(length(DDi)>=8);

DDo=[DDo,struct(‘D’,DDi(1:8),‘E’,0)];
DDi(1:8)=[ ];

end;

end

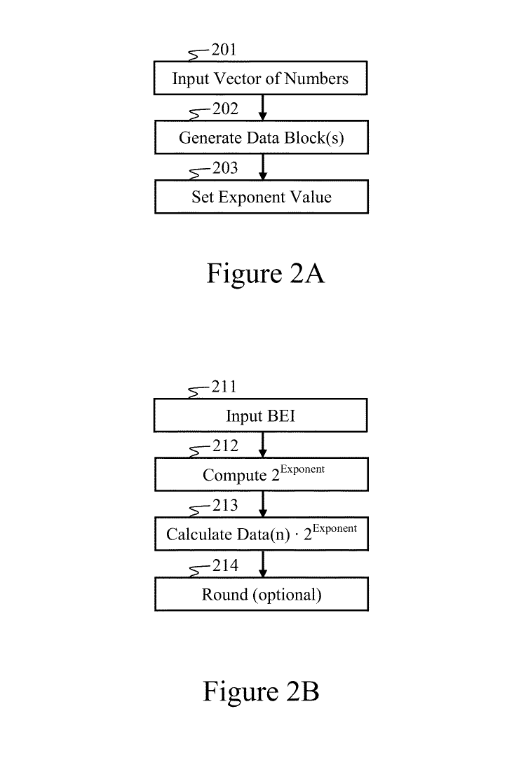

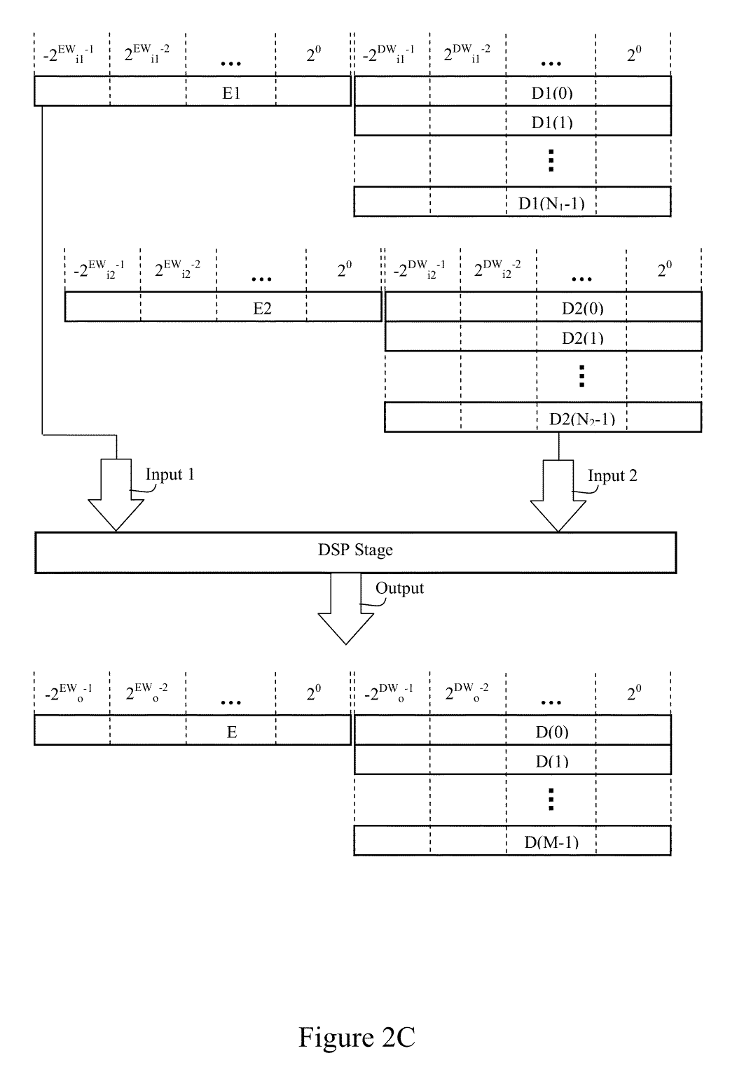

FIG. 2A is a flow diagram of a method for operating a digital processing system for converting a vector of decimal (i.e., base ten) numbers to BEI format. A vector of decimal numbers are input 201, from which data blocks having a predetermined dimension (i.e., parallel factor) (e.g., N=8) are generated 202. For each data block, an exponent value E is set 203.

The following pseudo code depicts a conversion of a vector of BEI-formatted numbers into a vector of numbers. A BEI array, DDi, is the input for both functions. The first function, Bei2DecFx, rounds the output, DDo, to the nearest integer. The second function, Bei2DecFx, does not round the output, DDo, which is the corresponding floating point value.

function Do=Bei2DecFx(DDi),

DDo=[ ];
while(length(DDi)>=1);

DDo=[DDo,nearest(DDi(1).D*2\hat{ }(DDi(1).E))];
DDi(1)=[ ];

end;

end
function DDo=Bei2DecFl(DDi),

DDo=[ ];
while(length(DDi)>=1);

DDo=[DDo,DDi(1).D*2\hat{ }(DDi(1).E)];
DDi(1)=[ ];

end;

end

FIG. 2B is a flow diagram of a method for operating a digital processing system for converting a set of numbers from BEI format into a vector of decimal (i.e., base ten) numbers. For each set of input BEI numbers 211, the corresponding exponent value 2^{E} is calculated 212 and then multiplied with each data part 213. In some aspects of the invention, the resulting product D·2^{E} may be rounded to the nearest integer. As used herein, the terms “round” and “rounding” may comprise rounding to the nearest integer, rounding to the nearest integer toward zero, rounding toward the nearest integer toward positive infinity, rounding toward the nearest integer toward negative infinity, or any combinations thereof.

In one aspect of the disclosure, a plurality of BEI blocks having the same data bit width DW, but different exponent values E, are operated on by an align function. The align function operates on at least one of the input BEI blocks to produce a set of output BEI blocks having a common exponent value E.

For example, given two BEI blocks, Di1(EW,DW) and Di2(EW,DW), if the exponent value (Di1.E) of block Di1 is less than the exponent value (Di2.E) of block Di2, a difference value (A) is calculated by subtracting the exponent value of Di1 from the exponent value of Di2:

A=Di2.E−Di1.E

The data part (Di1.D) of block Di1 is divided by 2^{A}, and the result is rounded down to the nearest integer (or floored down for simplifying a fixed-point implementation). The exponent value (Di1.E) of block Di1 is changed to the exponent value (Di2.E) of Di2.

Similarly, if the exponent value Di2.E is less than the exponent value Di1.E, the difference value A is calculated as: A=Di1.E−Di2.E. The data part Di2.D is divided by 2^{A}, and the result is rounded down to the nearest integer. The exponent value Di2.E is changed to Di1.E.

FIG. 2C depicts a digital signal processing (DSP) stage in accordance with an aspect of the invention. The stage comprises a first input (Input 1), a second input (Input 2), and an output. The first input is configured to receive a first set of BEI-formatted numbers comprising a block of N₁ data portions D₁(0), . . . , D₁(N−1) with a shared exponent, E₁. The data portions D₁(0), . . . , D₁(N₁−1) each have a fixed bit width of DWᵢ₁, and the exponent E₁ has a fixed bit width of EWᵢ₁. The second input is configured to receive a second set of BEI-formatted numbers comprising a block of N₂ data portions D₂(0), . . . , D₂(N₂−1) with a shared exponent, E₂. The data portions D₂(0), . . . , D₂(N₂−1) each have a fixed bit width of DWᵢ₂, and the exponent E₂ has a fixed bit width of EWᵢ₂. The DSP stage performs arithmetic operations on the input data, and the processed data is output from the stage. Data at the output comprises a set of BEI-formatted numbers, wherein a block of M data portions D(0), . . . , D(M−1) has a shared exponent, E. The data portions D(0), . . . , D(M−1) each have a fixed bit width of DWₒ, and the exponent E has a fixed bit width of EWₒ.

In accordance with one aspect of the invention, while the bit widths of the input and output blocks of the DSP stage are fixed, the internal state of the DSP stage may change the bit widths. For example, the stage may comprise a format optimizer to change bit widths EW and/or DW prior to the data being processed by an arithmetic processor. When BEI-formatted data is processed internally, the exponent part E has a fixed or variable bit width EW, and each of the data parts D in a block has the same bit width, DW, which may be variable. The bit widths, EW and/or DW, may be changed (e.g., reduced) to improve the system power efficiency while meeting a predetermined target system performance. For example, DW may be reduced when less resolution is required, and EW may be reduced when less dynamic range is required.

In one aspect of the invention, a data block having a specific bit width is processed by a specific hardware component. For example, a first hardware component (not shown) may be configured for processing a first set of BEI-formatted data (such as characterized by DWᵢ₁ and EWᵢ₁), and a second hardware component (not shown) may be configured for processing a second set of BEI-formatted data (such as characterized by DWᵢ₂ and EWᵢ₂). Each hardware component may comprise its own arithmetic processor and, optionally, a format optimizer.

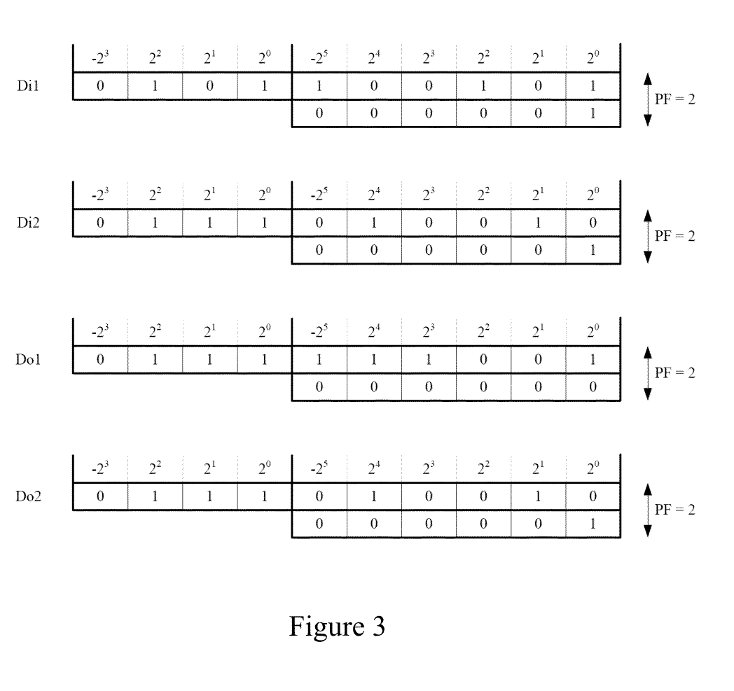

FIG. 3 depicts input and output data values associated with a BEI align function in accordance with one aspect of the invention. In this case, a first block Di1 is aligned relative to a second block Di2. Both blocks have a parallel factor PF=2. Since the exponent value Di1.E is 5 and the exponent value Di2.E is 7, A=2. The data part Di1.D(0)=−27. Thus, the output data part Do1.D(0)=round (Di1.D(0)/4)=−7, and the exponent part Do1.E=7. In this case, the alignment function slightly alters the original value of Di1·2^{Di1.E}=−864 to Do1·2^{Do1.E}=−896. Aligning the data part, Di1.D(1), results in Do1.D(1)=0.

Typically, data is aligned to the highest of the exponent values (e.g., max(Di1.E, Di2.E)). However, in some aspects of the invention, if all the data values in one of the blocks is zero, the exponent value(s) of the other block(s) is (are) not aligned higher, since the operation of divide-by-2^{A} and rounding results in some loss of information in the other block(s). Rather, the exponent value of each zero-valued block is aligned lower to the exponent value of the non-zero block.

The following pseudo-code illustrates an aspect of the invention in which an align function receives a pair of BEI blocks (inputs Di1 and Di2), a parallel factor PF, and a limit value Lim. The Lim value specifies a maximum limit for the difference between Di1.E and Di2.E. Above the Lim value, the data parts of the smaller-magnitude block Di1 or Di2 is set to zero and the smaller-magnitude block's exponent E is aligned to the exponent of the higher-magnitude block.

function [Do1,Do2]=BeiAlign(Di1,Di2,PF,Lim)

S1=sum(Di1.D==0);
S2=sum(Di2.D==0);
DWDiff=0;
if(S1==PF)&&(S2==PF),

Di1.E=0;
Di2.E=0;

elseif(S1==PF),

Di1.E=Di2.E;

elseif(S2==PF),

Di2.E=Di1.E;

end;
if(Di1.E−Di2.E>Lim),

Do1=Di1;
Do2.D=zeros(1,PF);
Do2.E=Di1.E;
return;

end;
if(Di2.E−Di1.E>Lim),

Do2=Di2;
Do1.D=zeros(1,PF);
Do1.E=Di2.E;
return;

end;
if Di1.E<Di2.E,

DWDiff=Di2.E−Di1.E;
Di1.D=floor(Di1.D/2\hat{ }DWDiff);
Di1.E=Di2.E;

elseif Di1.E>Di2.E,

DWDiff=Di1.E−Di2.E;
Di2.D=floor(Di2.D/2\hat{ }DWDiff);
Di2.E=Di1.E;

end;
Do1=Di1;Do2=Di2;

end

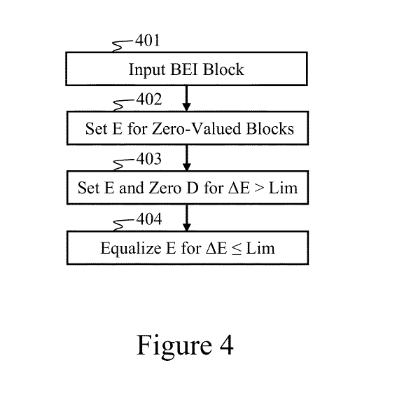

FIG. 4 is a flow diagram of a method for operating a digital processing system for aligning exponents of a set of numbers in BEI format. For each pair of input BEI blocks 401, the exponent E of at least one of the blocks is set if all of the data values D in at least one of the blocks is zero-valued 402. Specifically, if the data values of a first BEI block are all zero and at least one of the data values in a second BEI block is non-zero, the exponent of the first (i.e., zero-valued) block is set equal to the exponent of the second block. If the data values of both BEI blocks are all zero, then the exponents of both blocks may be set to zero.

In Step 403, the difference between exponent values of the first and second blocks is compared to a predetermined limit value, Lim. If the exponent of the first BEI block exceeds the exponent of the second BEI block by more than Lim, then the data values of the second BEI block are set to zero and the exponent value of the second BEI block is set equal to the exponent value of the first BEI block. Similarly, if the exponent of the second BEI block exceeds the exponent of the first BEI block by more than Lim, then the data values of the first BEI block are set to zero and the exponent value of the first BEI block is set equal to the exponent value of the second BEI block.

In Step 404, the exponent values of the first and second blocks are equalized if the difference in the exponent values is within the predetermined limit Lim. Specifically, if the exponent of the first BEI block is less than the exponent of the second BEI block, the exponent of the first BEI block is set equal to the exponent of the second BEI block, and the data values of the first BEI block are scaled by dividing the data values of the first BEI block by 2^{DWDiff}, where DWDiff equals the exponent of the second BEI block minus the exponent of the first BEI block. Similarly, if the exponent of the second BEI block is less than the exponent of the first BEI block, the exponent of the second BEI block is set equal to the exponent of the first BEI block, and the data values of the second BEI block are scaled by dividing the data values of the second BEI block by 2^{DWDiff} where DWDiff equals the exponent of the first BEI block minus the exponent of the second BEI block.

The following pseudo-code illustrates an aspect of the invention in which an optimize function receives a BEI block (input DDi) having a common exponent E and data width dw. The output comprises a BEI block DDo having a data width DW.

function DDo=SubBeiOptimize(DDi,dw,DW);

DDo=DDi;
if(0),return;end;
Dmax=MaxC(DDo.D);
Dmin=MinC(DDo.D);
F=1;
while(F==1),

if(Dmax<=2\hat{ }(dw−2)−1)&&(dw>DW)&&(Dmin>=−2\hat{ }(dw−2)),

DDo.D=DDo.D;
DDo.E=DDo.E;
dw=dw−1;

else F=0;
end;

end;
while(dw>DW),DDo.D=floor(DDo.D/2);

DDo.E=DDo.E+1;
dw=dw−1;

end;

end

function Max=MaxC(DDi);MaxR=max(real(DDi));MaxI=max(imag(DDi));Max=max(MaxR,MaxI);end function Min=MinC(DDi);MinR=min(real(DDi));MinI=min(imag(DDi));Min=min(MinR,MinI);end

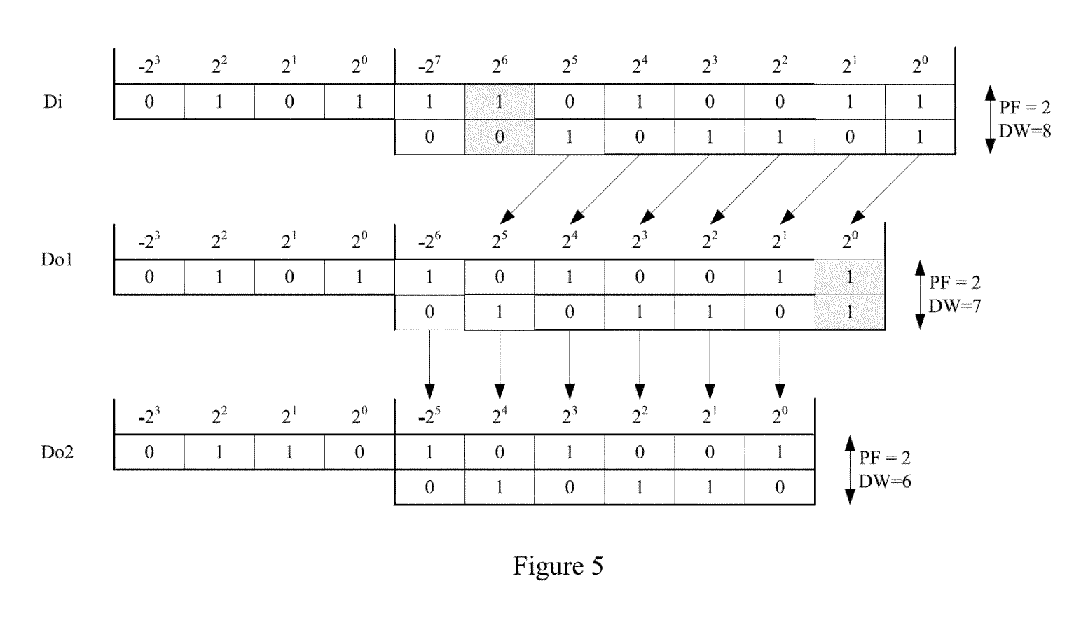

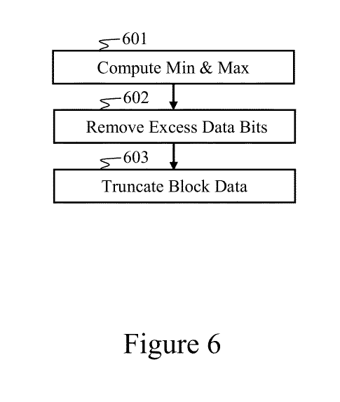

Functional aspects of the BEI optimize function are described with respect to the data operations depicted in FIG. 5 and the flow diagram shown in FIG. 6.

In the optimize function, the minimum and maximum values are computed 601 by first computing both Real and Imaginary parts of the data values of the BEI blocks. Then the minimum and maximum of the resulting values are computed. While the current block bit width dw is greater than the target bit width DW, the optimize function first determines if excess bits are used to represent the data values D. For example, if the maximum is less than 2^{(dw-2)}−1, then the positive data values in D can be equivalently represented by one less bit. If the minimum is greater than −2^{(dw-2)}, then the negative data values in D can be equivalently represented by one less bit. The block bit width dw is decremented 602 until either dw=DW or at least one data value D is outside the range of −2^{(dw-2)} to 2^{(dw-2)}−1. Each iteration of this process is equivalent to the reverse of a sign-extend operation, and may be implemented by removing the second most significant bit MSB(2) and performing a 1-bit logical right shift of the MSB(1). For example, as depicted in FIG. 5, the bits in DDi corresponding to MSB(2) are dropped, and a 1-bit logical right shift of the MSB(1) is performed to produce DDo1. Thus, the bit width DW is reduced from 8 to 7.

Next, while dw is greater than DW, the block data is truncated 603. For example, in each iteration, a 1-bit logical right shift is implemented in which the least significant bit, LSB(0), is lost. But instead of adding a zero to the MSB(1), the MSB(1) bit position is removed, which decrements dw. The exponent value E is incremented by 1. This is depicted in FIG. 5 to produce DDo2. Thus, the bit width DW is reduced from 7 to 6.

In some aspects of the invention, BEI format may comprise one or more unused bit positions being eliminated without implementing a corresponding logical shift. For example, a modified 2's complement format may comprise a most significant bit, MSB(1), whose weight is the negative of its corresponding power of two (e.g., −2^{DW}), and a second most significant bit, MSB(2), that has a weight of 2^{DW-2}. In other aspects, one or more additional or alternative bit positions that are not used by the BEI block may be eliminated, such as by employing the BEI optimize function.

BEI addition and subtraction functions may be configured to operate on a pair of aligned blocks Di1 and Di2. The blocks Di1 and Di2 have the same exponent value E, and the same data bit width DW. For example, addition comprises 1-bit sign extending and then adding the data parts: Di1.D+Di2.D. The sum has a bit width of Di1.DW+1.

The following pseudo code several aspects in which BEI addition may be performed.

function [DDo]=BeiAdd(DDi1,DDi2,PF,Lim),

[DDi1,DDi2]=BeiAlign(DDi1,DDi2,PF,Lim);
DDo.D=DDi1.D+DDi2.D;
DDo.E=DDi1.E;

End
function DDo=BeiAddOptimize(DDi1,DDi2,PF,iDW,oDW,Lim),

[DDi1,DDi2]=BeiAlign(DDi1,DDi2,PF,Lim);
DDo.D=DDi1.D+DDi2.D;
DDo.E=DDi1.E;
Ddo=BeiOptimize(DDo,iDW,oDW);

end

In one aspect of the invention, a BEI Addition function receives a pair of BEI blocks DDi1 and DDi2, a parallel factor PF, and a limit value Lim. The parallel factor PF and limit Lim are employed in a BEI Align function to align the BEI blocks DDi1 and DDi2. Then addition is performed on the data parts Di1.D and Di2.D of the aligned BEI blocks.

In another aspect of the invention, a BEI Addition function receives a pair of BEI blocks DDi1 and DDi2, a parallel factor PF, a limit value Lim, an input data width iDW for the input BEI blocks, and an output data width oDW for the block of the resultant sum. A BEI Align function aligns the BEI blocks DDi1 and DDi2 before addition. The resulting sum DDo is optimized by a BEI Optimize function, which receives DDi, iDW, and oDW, and outputs an optimized sum with data width oDW.

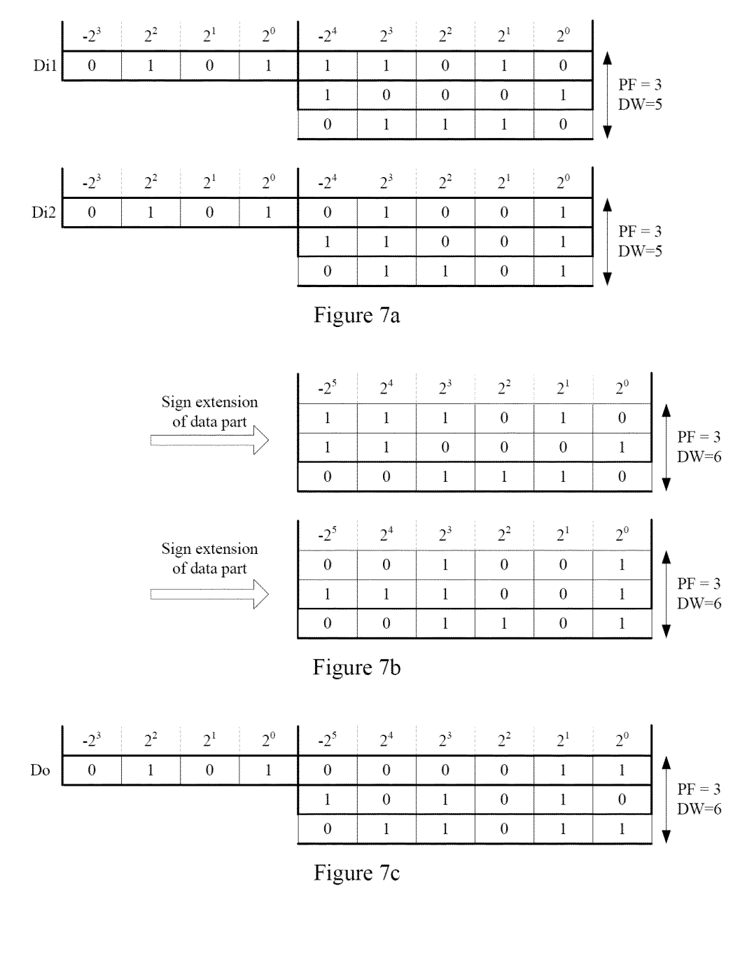

FIGS. 7A, 7B, and 7C each depict a process whereby a pair of BEI-formatted numbers are summed. The data portion D of each BEI number (e.g., Do1 and Do2 shown in FIG. 7A) is sign extended by one bit, which is depicted in FIG. 7B. The sign-extended data portions are summed: Di1.D+Di2.D, whereas the exponential portion E of the sum has the same exponent value E and exponent bit width EW as the pair of BEI numbers Do1 and Do2. The resulting sum is shown in FIG. 7C.

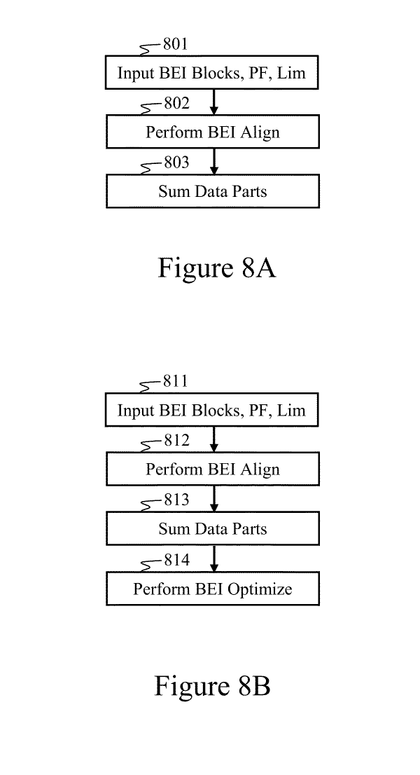

FIG. 8A is a flow diagram of a method for operating a digital processing system for summing a pair of numbers in BEI format according to an aspect of the invention. A pair of BEI blocks, a parallel factor PF, and a limit value Lim are received as inputs 801. A BEI align function is performed on the pair of BEI blocks 802 before the data portion D of the blocks is summed 803.

FIG. 8B is a flow diagram of a method for operating a digital processing system for summing a pair of numbers in BEI format according to another aspect of the invention. A pair of BEI blocks, a parallel factor PF, and a limit value Lim are received as inputs 811. A BEI align function is performed on the pair of BEI blocks 812 before the data portion D of the blocks is summed 813. The resulting sum is processed by a BEI optimize function 814.

In yet another aspect of the invention, multiplication of a pair of BEI numbers is performed. As shown in the following pseudo-code, the BEI numbers, Di1 and Dig, are the input operands to a multiplier.

function [DDo]=BeiMul(DDi1,DDi2),

DDo.D=DDi1.D*DDi2.D;
DDo.E=DDi1.E+DDi2.E;

end

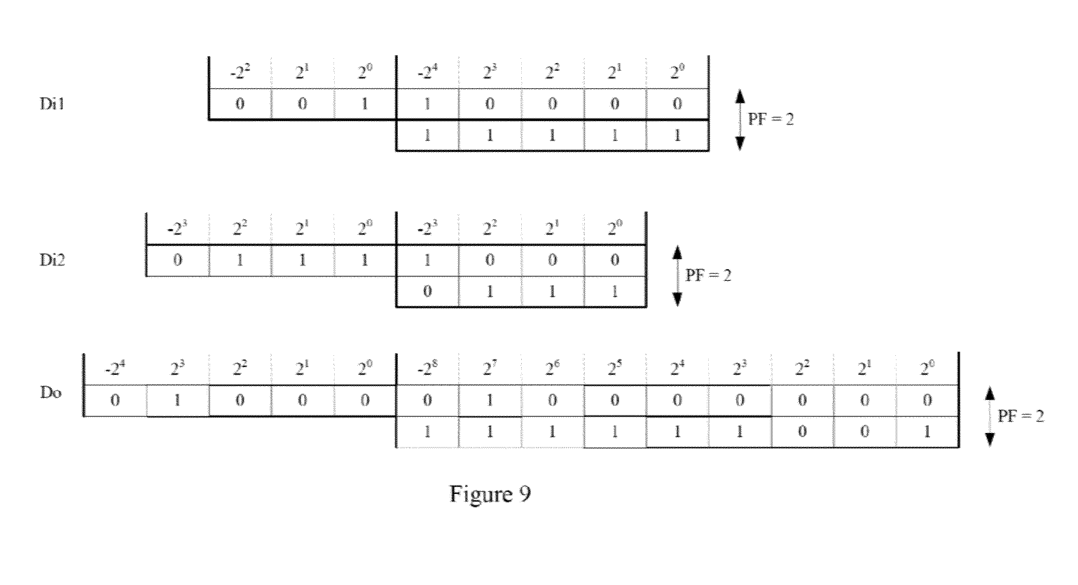

The EW and/or DW of the numbers to be multiplied may differ. Multiplication of the data parts D comprises allocating a data bit width that equals the sum of data bit widths of the two numbers being multiplied, such as depicted in FIG. 9. Multiplication of the exponent parts comprises finding the maximum exponent bit width of the two numbers and adding one to the maximum bit width: max(Di1.EW,Di2.EW)+1. The resulting product DDo is optimized by a BEI Optimize function, which receives DDo, iDW, and oDW, and outputs an optimized product with data width oDW.

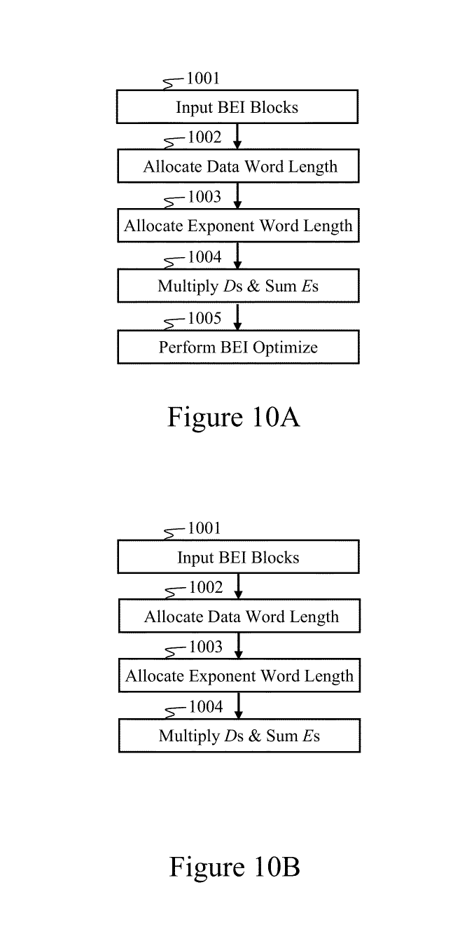

FIG. 10A is a flow diagram of a method for operating a digital processing system for multiplying a pair of BEI blocks according to an aspect of the invention. The pair of BEI blocks is received as input operands 1001. Allocating a DW for the resulting product 1002 comprises allocating a DW that equals the sum of data bit widths of the two blocks being multiplied. Allocating an EW for the resulting product 1003 comprises adding one to the maximum EW of the pair of BEI blocks. The data portions of the BEI blocks are multiplied and the exponent portions are summed 1004. A BEI-optimize function may be performed 1005 on the resulting product.

FIG. 10A is a flow diagram of a method for operating a digital processing system for multiplying a pair of BEI blocks according to another aspect of the invention, wherein no BEI-optimize function is performed on the product generated in step 1004.

While some aspects of the invention depict a number with a BEI representation being equal to D·2^{E}, other aspects may employ a non-base 2 exponent. For example, alternative BEI representations include D·2^{2·E} and D·2^{(2·E+1)}. When the BEI representation D·2·E is employed, the exponent 2·E has incremental values of 2. If E is a 2's complement number with 3-bits (EW), then the exponent 2·E has a value from the set {−6, −4, −2, 0, 2, 4}. Similarly, the exponent 2·E+1 also has a step size of 2 and includes any value from the set {−5, −3, −1, 1, 3, 5}. Thus, in some aspects of the invention, the value of a number with a BEI format equals D·2^{a·E} or D·2^{(a·E+1)}, where a represents the step size.

The methods and systems described herein merely illustrate particular aspects of the invention. It should be appreciated that those skilled in the art will be able to devise various arrangements, which, although not explicitly described or shown herein, embody the principles of the invention and are included within its scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for operating a digital processing system, comprising:
generating input data having a block exponent integer format, wherein each block comprises a plurality of data values sharing a single exponent, the plurality of data values having a common data bit width and the exponent having an exponent bit width; and
reducing at least one of the data bit width and the exponent bit width prior to or after performing arithmetic operations to improve system power efficiency while meeting a predetermined target system performance.

2. The method recited in claim 1, wherein reducing comprises at least one of reducing the data bit width when less resolution is required and reducing the exponent bit width when less dynamic range is required.

3. The method recited in claim 1, wherein the block exponent integer format comprises a first block having a first data bit width (DW₁) and a first exponent bit width (EW₁) and a second block having a second data bit width (DW₂) and a second exponent bit width (EW₂), the method employing a first hardware component for processing the first block and a second hardware component for processing the second block if at least one of DW₁≠DW₂ and EW₁≠EW₂.

4. The method recited in claim 1, wherein reducing comprises:
determining a target bit width for the data bit width, the target bit width being less than the data bit width;
decrementing the data bit width by removing any unused most significant bits (MSB)s from the data values; and
while the data bit width is greater than the target bit width, truncating at least one least significant bit (LSB(0)) of the data values and increasing the exponent value.

5. The method recited in claim 4, wherein truncating comprises dividing each data value by a power of two for producing a quotient, and rounding the quotient.

6. The method recited in claim 4, wherein decrementing the data bit width comprises determining a minimum value and a maximum value for the array of data values for determining at least one unused MSB.

7. A digital processing system, comprising:
an input configured for receiving input data in block exponent integer format, wherein each block comprises a plurality of data values sharing a single exponent, the plurality of data values having a common data bit width and the exponent having an exponent bit width; and
an arithmetic processor configured for performing arithmetic operations on the input data to produce output data in block exponent integer format, the arithmetic processor comprising a format optimizer for reducing at least one of the data bit width and the exponent bit width prior to or after performing arithmetic operations to improve system power efficiency while meeting a predetermined target system performance.

8. The digital processing system recited in claim 7, wherein reducing comprises at least one of reducing the data bit width when less resolution is required and reducing the exponent bit width when less dynamic range is required.

9. The digital processing system recited in claim 7, wherein the block exponent integer format of the input data comprises a first block having a first data bit width (DW₁) and a first exponent bit width (EW₁) and a second block having a second data bit width (DW₂) and a second exponent bit width (EW₂), the arithmetic processor employing a first hardware component for processing the first block and a second hardware component for processing the second block if at least one of DW₁≠DW₂ and EW₁≠EW₂.

10. The digital processing system recited in claim 7, wherein reducing comprises:
determining a target bit width for the data bit width, the target bit width being less than the data bit width;
decrementing the data bit width by removing any unused most significant bits (MSB)s from the data values; and
while the data bit width is greater than the target bit width, truncating at least one least significant bit (LSB(0)) of the data values and increasing the exponent value.

11. The digital processing system recited in claim 10, wherein truncating comprises dividing each data value by a power of two for producing a quotient, and rounding the quotient.

12. The digital processing system recited in claim 10, wherein decrementing the data bit width comprises determining a minimum value and a maximum value for the array of data values for determining at least one unused MSB.

13. A method for operating a digital processing system having a data input comprising a first block comprising a first plurality of data values sharing a first exponent, and a second block comprising a second plurality of data values sharing a second exponent, the first exponent being greater than the second exponent; the method comprising:
determining if the first exponent exceeds the second exponent by less than a predetermined limit value; and
upon determining that the first exponent exceeds the second exponent by less than the predetermined limit value, setting the second exponent equal to the first exponent and scaling down the second data portion by a base raised to a power of the second exponent minus the first exponent.

14. The method recited in claim 13, further comprising setting the first exponent equal to the second exponent if all data values in the first data portion equal zero and at least one of the data values in the second data portion is non-zero.

15. The method recited in claim 13, further comprising setting the first exponent and the second exponent to zero if all data values in the first data portion and in the second data portion equal zero.

16. The method recited in claim 13, further comprising setting the second data portion equal to zero and setting the second exponent equal to the first exponent if the first exponent exceeds the second exponent by the predetermined limit value.

17. The method recited in claim 13, wherein the base equals two.

18. The method recited in claim 13, wherein scaling the second data portion produces a scaled second data portion, and the scaled second data portion is rounded downward to a nearest integer.

19. The method recited in claim 13, wherein the first block and the second block are summands of an addition operation.
